(19) United States
(12) Patent Application Publication
(10) Pub. No.: US 2026/0170052 A1
(43) Pub. Date: Jun. 18, 2026

(54) SYSTEM FOR SEARCHING MUSIC BASED ON COMBINATION OF COMPONENTS OF MUSIC AND METHOD THEREOF

(71) Applicant: KEISER Inc., Incheon (KR)

(72) Inventor: DuHeon Gyeon, Incheon (KR)

(21) Appl. No.: 19/341,649

(22) Filed: Sep. 26, 2025

(30) Foreign Application Priority Data
Dec. 13, 2024 (KR) 10-2024-0186374

(51) Int. Cl. G06F 16/635; G06F 16/61

(52) U.S. Cl. CPC G06F 16/636; G06F 16/61

(57) ABSTRACT

The present disclosure relates to a music search system based on a combination of components of music and a method thereof. The system may include: a learning unit which trains a learning model by setting a plurality of candidate music as input data and setting a level value for a main category as output data; a database which quantizes and stores an attribute for each main category for each extracted candidate music as a level value; an input unit which receives a level value for at least one main category from a user; and a searching unit which inputs the input level value for each main category to a previously trained learning model to search one or more candidate music and provide the searched candidate music to a user terminal.

### CROSS-REFERENCE TO RELATED APPLICATIONS

This application claims the priority of Korean Patent Application No. 10-2024-0186374 filed on Dec. 13, 2024, in the Korean Intellectual Property Office, the disclosure of which is incorporated herein by reference.

### BACKGROUND

### Field

The present disclosure relates to a system for searching music based on a combination of components of music and a method thereof, and more particularly, to a system for searching music based on a combination of components of music which allows a user to search a plurality of music through artificial intelligence and a method thereof.

### Description of the Related Art

Since the Internet has developed, music has been shared at a rapid tempo around the world and recently, it is possible to access a music online through streaming services. Accordingly, nowadays, all commercial music around the world is available through streaming music services. However, among the large number of music, it is extremely difficult to find music and sound sources which match specific characteristics one intends. This is because the search is performed based on a tag which is input in advance, such as an artist's name, a music title, and a genre. However, such data does not represent the specific characteristics of music at all. As a simple example, even essential elements, such as whether a piece of music is fast or slow, cannot be distinguished using traditional filtering or text search methods.

In other words, the existing music searching methods do not specifically classify the genre components of the music itself to allow a listener to directly search, recommend, and select music characteristics according to the listener's intention through the results, but mainly follows the results that many others have listened to.

For example, it reflects cumulative statistics, such as what kind of music people who listen to BTS's “DREAMER” often listen to. Therefore, it is difficult to accurately search music with characteristics desired by the user and specific characteristics of the music are not defined for searching.

This approach inevitably results in recommending and searching only music under the influence of large and mid-sized agencies which invest in marketing other than music, so that music which is less well-known, despite its quality, cannot be listened to or utilized.

Accordingly, a system for searching music using artificial intelligence has become necessary.

The background art of the present disclosure is disclosed in Korean Registered Patent No. 10-0895009 (published on Apr. 24, 2009).

### SUMMARY

A technical object to be achieved by the present disclosure is to provide a music search system based on a combination of components of music which evaluates a plurality of music by artificial intelligence to allow a user to search music and a method thereof.

In order to achieve the above-described technical object, according to an aspect of the present disclosure, a music search system based on a combination of components of music includes a learning unit which trains a learning model by setting a plurality of candidate music as input data and setting a level value for a main category including a tempo, a beat, an electric (EDM), a vocal, a spatial density, a time density, a brightness, and a popularity for the music, as output data; a database which quantizes and stores an attribute for each main category for each extracted candidate music as a level value; an input unit which receives a level value for at least one main category, among the tempo, the beat, the electric (EDM), the vocal, the spatial density, the time density, the brightness, and the popularity, from a user; and a searching unit which inputs the input level value for each main category to a previously trained learning model to search one or more candidate music and provide the searched candidate music to a user terminal.

The input unit may further receive at least one search keyword, among a title, a singer's name, an album title, and lyrics, from a user and further receive a sub category for the main category.

When the main category is a vocal, a sub category of the vocal is classified into normal/rap/mixed based on a music style, is classified into normal/introvert based on the lyrics, is classified into general/Christian/Buddhish music based on the religion, and is classified into male and female based on the gender.

When the main category is a spatial density, a sub category of the spatial density is classified into general, Western classic, and Oriental classic based on a music style and when the main category is a time density, a sub category of the time density is classified into general, rock, and jazz based on the music style.

The search unit additionally inputs a search keyword input by the user and a sub category selected by the user to a learning model to search one or more candidate music.

The music search system may further include a reproducer which, if music selected from the candidate music is input from the user, receives the selected music from a music content providing server in a streaming manner to play the music through the user terminal.

A level value for the main category is set to five levels and an initial level value may be set to a reference level.

The input unit may further receive at least one user information including gender, age, nationality, occupation, religion, a residential area, mainly used time line of the user terminal, MBTI information, and a blood type. The learning unit may train the learning model by setting the plurality of user information as input data and setting a level value set for the main category of each user as output data.

The learning unit may set an initial level value for each main category using user information of the corresponding user in advance.

According to the learning model, the tempo category is trained with a higher level value for a faster tempo, the beat category is trained with a higher level value for a stronger rhythm intensity, the electric (EDM) category is trained with a higher level value as a proportion occupied by electronic sound, an effect modulation, and a sound effect in the music increases, the vocal category is trained with a higher level as a proportion of the vocal in the music increases, the spatial density category is trained with a higher level value as more instruments and sound types are played simultaneously, the time density category is trained with a lower level value as a gap of the playing time is longer, the brightness category is trained with a lower level value as the atmosphere is brighter, and the popularity category is trained with a higher level value as it is less likely to be disliked by an unspecified number of people.

The learning model may be based on a temporal convolution network (TCN) algorithm.

According to another aspect of the present disclosure, a music search method performed by a music search system includes a step of training a learning model by setting a plurality of candidate music as input data and setting a level value for a main category including a tempo, a beat, an electric (EDM), a vocal, a spatial density, a time density, a brightness, and a popularity for the music, as output data; a step of quantizing and storing an attribute for each main category for each extracted candidate music as a level value; a step of receiving a level value for at least one main category, among the tempo, the beat, the electric (EDM), the vocal, the spatial density, the time density, the brightness, and the popularity, from a user; and a step of searching one or more candidate music and providing the searched candidate music to a user terminal by inputting the input level value for each main category to a previously trained learning model.

According to the present disclosure, as described above, music which reflects user's interest may be searched and a sound source may be searched by setting only a level value for each main category without additional calculations so that user's favorite music can be provided within a short time.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram for explaining a configuration of a music search system according to an exemplary embodiment of the present disclosure;

FIG. 2 is a view illustrating a configuration of a music search system according to an exemplary embodiment of the present disclosure;

FIG. 3 is a flowchart for explaining a learning process by a learning model for a music search method according to an exemplary embodiment of the present disclosure;

FIG. 4 is an exemplary diagram illustrating an input screen of a user terminal according to an exemplary embodiment of the present disclosure;

FIGS. 5A and 5B are views enlarging an interface for selecting a sub category in FIG. 4; and

FIG. 6 is an exemplary diagram illustrating an output screen of a user terminal according to an exemplary embodiment of the present disclosure.

### DETAILED DESCRIPTION OF EXEMPLARY EMBODIMENTS

Hereinafter, the present disclosure will be described more fully with reference to the accompanying drawings, in which exemplary embodiments of the present disclosure are shown. However, the present disclosure can be realized in various different forms, and is not limited to the exemplary embodiments described herein. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

Hereinafter, the present disclosure will be described more fully with reference to the accompanying drawings, in which exemplary embodiments of the present disclosure are shown.

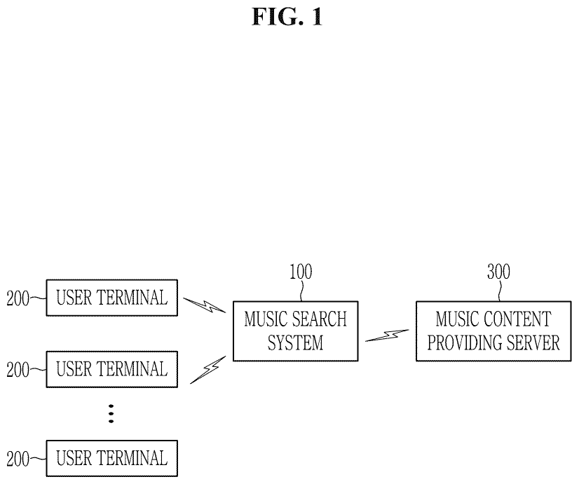

FIG. 1 is a diagram for explaining a configuration of a music search system according to an exemplary embodiment of the present disclosure.

As illustrated in FIG. 1, a music search system 100 according to an exemplary embodiment of the present disclosure is connected to one or more user terminals 200 via a network and is also connected to a music content providing server 300 via a network.

The music search system 100 according to the exemplary embodiment of the present disclosure is connected to the user terminal 200 via a wired, wireless, or combined wired/wireless network to transmit and receive information. The wireless network may include at least one of RF, WLAN, Wi-FI, and Bluetooth, and use various known wireless network methods.

Such a music search system 100 may be implemented as an on-line platform, such as a web server or an app server, which provides an artificial intelligence-based depression level prediction service to the user terminal 200 or may be implemented in the user terminal as an application program, application, etc.

The music search system 100 may supply a user-customized music search platform which is implemented as an application or a web to the user terminal 200 connected through a network. The service platform may be an application program which runs in an App or a Web environment.

As described above, the music search system 100 may be implemented as a platform server which supplies a music search service or an application program (application) which runs on the user terminal 200, by taking into account the user's taste and preference. The user terminal 200 is connected to the system 100 through a network while a related application program is running to receive a related service.

The user terminal 200 may include a device which is connected to a wired/wireless network to transmit or receive information, such as a PC, a desktop, a smart phone, a tablet, or a notebook.

When the user requests, the music content providing server 300 transmits a selected sound source content to the user terminal 200 through the music search system 100.

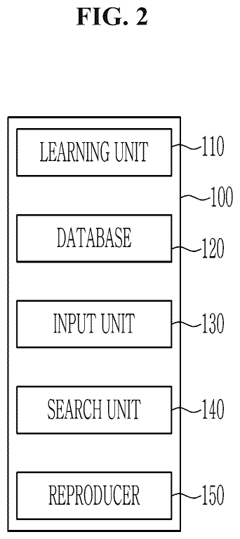

Hereinafter, the music search system 100 according to the exemplary embodiment of the present disclosure will be described with reference to FIG. 2.

FIG. 2 is a view illustrating a configuration of a music search system according to an exemplary embodiment of the present disclosure.

The music search system 100 according to the exemplary embodiment of the present disclosure may include a learning unit 110, a database 120, an input unit 130, and a search unit 140 and further include a reproducer 150.

First, the learning unit 110 trains a learning model by setting a plurality of candidate music as input data and setting a level value for a main category including a tempo, a beat, an electric (EDM), a vocal, a spatial density, a time density, a brightness, and a popularity with respect to the music, as output data.

At this time, the learning model is trained by applying a score of a domain-specific attribute according to a feature vector to a temporal convolution network (TCN) algorithm.

The learning unit 110 analyzes a plurality of feature parameters for one or more candidate music which have been stored in advance, applies the plurality of analyzed feature parameters to Boruta technique to extract a feature vector for each candidate music, and applies the feature vector to the previously trained learning model to extract a domain-specific attribute for each candidate music.

Here, the Boruta technique is a method for selecting a random forest-based variable and is used to extract a feature vector for each candidate music in the present disclosure.

At this time, the component of the music includes at least one main category, among a tempo, a beat, electric (EDM), a vocal, a spatial density, a time density, a brightness, and a popularity.

Next, the database 120 quantizes and stores an attribute for each main category of candidate music extracted from the learning unit 110 as a level value.

The input unit 130 receives a level value for at least one of the main categories including the tempo, the beat, the electric (EDM), the vocal, the spatial density, the time density, the brightness, and the popularity, according to the user's taste and preference, from the user through the user terminal 200.

Further, the input unit 130 may further receive at least one search keyword among a title, an artist name, an album title, and lyrics, from the user and may further receive sub categories for the main category.

When the level value for each input main category is input from the user, the search unit 140 applies the level value to the learning model to select one or more corresponding candidate music from the database 120 and search from the user terminal 200.

The reproducer 150 receives music selected by the user from the music content providing server 300 to be reproduced in the user terminal 200 in a streaming manner.

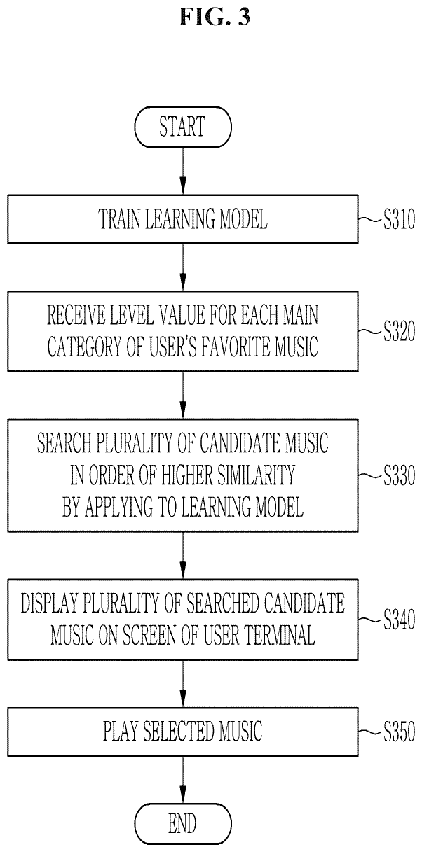

Hereinafter, a music search method according to an exemplary embodiment of the present invention will be described with reference to FIGS. 3 to 6.

FIG. 3 is a flowchart for explaining a learning process by a learning model for a music search method according to an exemplary embodiment of the present disclosure.

First, the learning unit 110 trains a learning model by setting a plurality of candidate music as input data and setting a level value for a main category including a tempo, a beat, an electric (EDM), vocal, a spatial density, a time density, a brightness, and a popularity with respect to the music, as output data in step S310.

At this time, the learning model is trained by applying a score of a domain-specific attribute according to a feature vector to a temporal convolution network (hereinafter, abbreviated as TCN) algorithm.

The TCN is a kind of neural network which is designed for processing data in a time order. The TCN is a one-dimensional (1D) convolution network and is mainly used for sequential data tasks, such as time series prediction, action recognition, and signal processing. Unlike the recurrent neural network (RNN), the TCN processes the entire sequence at once, which enables parallelization and also effectively operates even on a long sequence.

One of main features of the TCN is that it predicts the future by considering only the past information by using a causal convolution and covers a wide temporal range through a dilated convolution.

Further, the level values for the main categories including the tempo, the beat, the electric (EDM), the vocal, the spatial density, the time density, the brightness, and the popularity are set to five levels and a reference level is set to level 3.

Here, according to the learning model, the tempo category is trained with a higher level value for a faster tempo and the beat category is trained with a higher level value for a stronger rhythm intensity. The electric (EDM) category is trained with a higher level value as a proportion occupied by electronic sound, an effect modulation, and a sound effect in the music increases.

The vocal category is trained with a higher level value as a proportion of the vocal in the music increases and the spatial density category is trained with a higher level value as more instruments and sound types are played simultaneously.

Further, according to the learning model, the time density category is trained with a lower level value as a gap of the playing time is longer and the brightness category is trained with a lower level value as the atmosphere is brighter.

The popularity category is trained with a higher level value as it is less likely to be disliked by an unspecified number of people.

At this time, the learning unit 110 analyzes a plurality of feature vectors for one or more candidate music which have been stored in advance and applies the plurality of analyzed feature vectors to the Boruta technique to perform the labeling task.

As described above, when the learning is finished by the learning model, level values for eight main categories including the tempo, the beat, the electric (EDM), the vocal, the spatial density, the time density, the brightness, and the popularity for each candidate music are stored in the database 120.

When the learning process is finished as described above, the input unit 200 receives a level value for each main category of a favorite music from the user through the user terminal 200 in step S320.

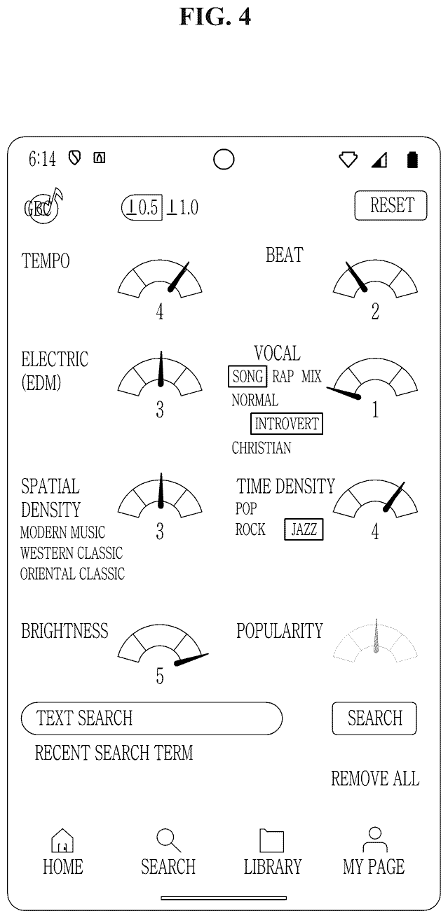

FIG. 4 is an exemplary diagram illustrating an input screen of the user terminal according to an exemplary embodiment of the present disclosure.

As illustrated in FIG. 4, the user may set a preferred level for each main category of the tempo, the beat, the electric (EDM), the vocal, the spatial density, the time density, the brightness, and the popularity.

Here, the level value for each main category is set to five levels from level 1 to level 5 and a reference level value corresponding to an average level is set to level 3.

Accordingly, when the user executes the application with the user terminal 200, initial level values of eight main categories are set to level 3 which is a reference level.

At this time, according to the exemplary embodiment of the present disclosure, it is described that the level values are divided into five levels, but according to the user's choice, the levels can be subdivided to be divided and set in increments of 0.1 level or 0.5 level.

Further, as illustrated in the left upper end of FIG. 4, a level setting range can be selected to ±0.5 or ±0.1.

Accordingly, in a state in which the tempo category is set to level 2, if the user selects ±0.5, music having a tempo between level 1.5 to level 2.5 is searched.

In the meantime, the input unit 130 further receives at least one user information including gender, age, nationality, occupation, religion, a residential area, a mainly used time line of the user terminal, MBTI information, and a blood type from a plurality of users. The learning unit 110 trains the learning model by setting the plurality of user information as input data and setting a level value set for the main category of each user as output data.

By doing this, when the user executes the application with the user terminal 200, the learning unit 110 sets an initial level value in advance for each main category using user information of the corresponding user.

For example, when a user is a 23-year-old female university student who lives near Hongdae, a level value of the tempo category is initially set to level 4 and the time density is initially set to level 2 based on the training result of the learning model.

Further, the user may further receive at least one keyword, among a title keyword, a singer name, an album title, and lyrics of a desired music, through a search window.

At this time, the user may further select a sub category for each main category.

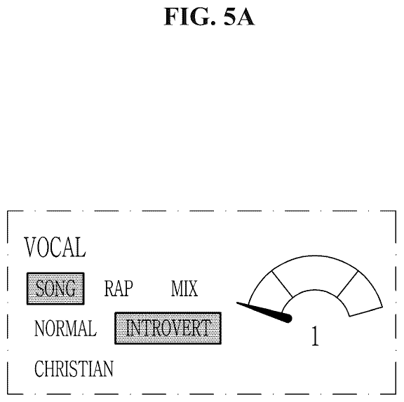

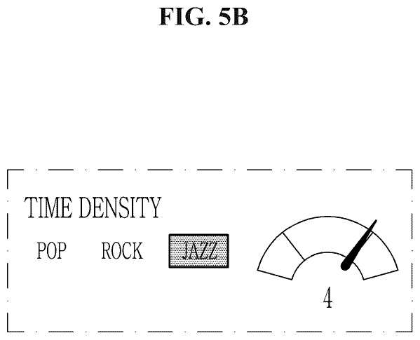

FIGS. 5A and 5B are views enlarging an interface for selecting sub categories in FIG. 4.

Specifically, FIG. 5A is a view enlarging a sub category for a vocal category and FIG. 5B is a view enlarging a sub category for a time density category.

That is, as illustrated in FIGS. 5A and 5B, an interface for selecting a sub category may be additionally implemented in a lower end of each main category.

For example, in the case of the vocal, as illustrated in FIG. 5A, the vocal may be classified into normal/rap/mixed based on the style of instruments or performance and may be classified into normal/introvert based on the lyrics.

Here, the “introvert” is an indicator representing a degree of sadness in the lyrics so that when a user wants to listen to songs with sad lyrics, the introvert sub category may be selected.

Further, the vocal may be classified into general/Christian/Buddhish music based on the religion so that the user may directly select a desired religious music through the corresponding sub category. Likewise, the gender may be classified into “male” and “female” to allow the user to make a selection.

The spatial density may be classified into general/Western classic/Oriental classic according to the music style to allow the user to make a selection.

Further, as illustrated in FIG. 5B, the time density may be classified into normal/rock/jazz according to the music style to allow the user to directly make detailed selection.

In the meantime, when the user touches the same sub category two times, the search may be performed excluding only the corresponding sub category.

For example, when the user selects Christian two times, the search may be performed while excluding only the Christian music.

By doing this, the search unit 140 applies an input level value for each main category to the previously trained learning model to search a plurality of candidate music in the order of higher similarity in step S330.

That is, the learning unit 110 applies the input level value for each main category, a search keyword input by the user, and a sub category selected by the user to the learning model to search the plurality of candidate music.

For example, when the user selects level 2 for the tempo category, selects level 2 for the brightness category, and inputs “cloud” as a search keyword, the learning unit 110 searches for a candidate music in which the tempo is somewhat slow, the brightness is high, and the music title or lyrics include the word “cloud”.

As described above, according to the exemplary embodiment of the present disclosure, the search is possible by combining a component of the music and the search keyword so that the music which matches a desired mood and targets a specific subject can be searched.

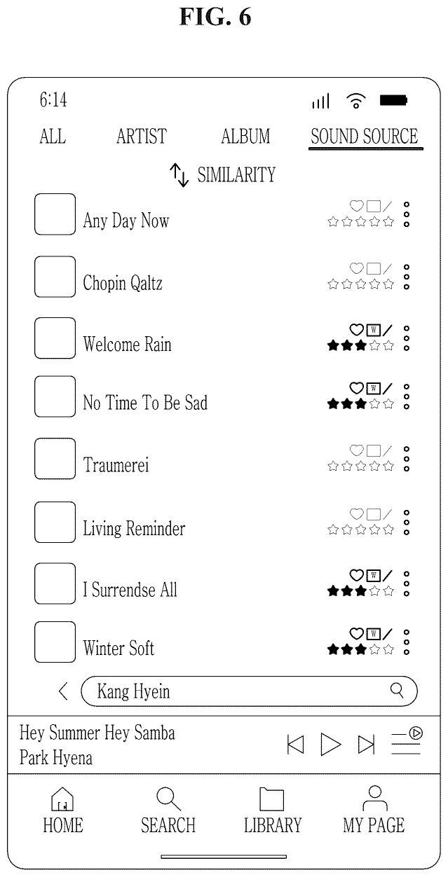

Next, the search unit 140 displays the plurality of searched candidate music on a screen of the user terminal 200 as illustrated in FIG. 6 in step S340.

FIG. 6 is an exemplary diagram illustrating an output screen of a user terminal according to an exemplary embodiment of the present disclosure.

As illustrated in FIG. 6, the search unit 140 provides one or more music to be searched through the screen of the user terminal 200.

Next, if the user selects any one of the plurality of candidate music, the reproducer 150 plays the corresponding music in step S350.

At this time, the sound source content providing server 300 transmits the stored music to the music search system 100 in a streaming manner and the music search system 100 plays the corresponding music in the user terminal 200 through the reproducer 150.

As described above, according to the exemplary embodiment of the present disclosure, music which reflects the preference and the taste of the user may be searched to be customized for the user and the artificial intelligence learning model is used to enable the search of the sound source by inputting only a score for each category so that the user's favorite music may be provided within a short time.

Further, according to the exemplary embodiment of the present disclosure, data on music ratings evaluated by the user and frequently listened to music are combined to provide an analysis service for the user's musical preference.

That is, if an average of level values of the main category for user's favorite music is calculated, the user's musical preference can be identified and the musical preference of the other party can be shared.

Accordingly, it is possible to share information indicating that other users most frequently listen to bright music with fast tempo and sung by female vocals or most frequently listen to music centered on electronic sound with strong beats.

By doing this, search and matching for users with similar musical preferences are possible. Until now, due to ambiguous and imprecise musical preferences and fragmented genres numbering in the thousands, objectively defining music genres has been practically impossible. However, according to the exemplary embodiment of the present disclosure, a user's musical preferences can be accurately identified, and matching with users having similar preferences is also possible.

The present disclosure has been described with reference to the exemplary embodiment illustrated in the drawing, but the exemplary embodiment is only illustrative, and it would be appreciated by those skilled in the art that various modifications and equivalent exemplary embodiments may be made. Therefore, the true technical scope of the present disclosure should be defined by the technical spirit of the appended claims.

What is claimed is:

1. A music search system based on a combination of components of music, comprising:
a learning unit which trains a learning model by setting a plurality of candidate music as input data and setting a level value for a main category including a tempo, a beat, an electric (EDM), a vocal, a spatial density, a time density, a brightness, and a popularity for the music, as output data;
a database which quantizes and stores an attribute for each main category for the each extracted candidate music as the level value;
an input unit which receives the level value for at least one main category, among the tempo, the beat, the electric (EDM), the vocal, the spatial density, the time density, the brightness, and the popularity, from a user; and
a searching unit which inputs the input level value for each main category to the previously trained learning model to search one or more candidate music and provide the searched candidate music to a user terminal.

2. The music search system according to claim 1, wherein the input unit further receives at least one search keyword, among a title, a singer's name, an album title, and lyrics, from the user and further receives a sub category for the main category.

3. The music search system according to claim 2, wherein when the main category is the vocal, a sub category of the vocal is classified into normal, rap, and mixed based on a music style, is classified into normal and introvert based on the lyrics, is classified into general, Christian, and Buddhish music based on religion, and is classified into male and female based on gender.

4. The music search system according to claim 2, wherein when the main category is the spatial density, a sub category of the spatial density is classified into general, Western classic, and Oriental classic based on a music style and when the main category is the time density, a sub category of the time density is classified into general, rock, and jazz based on the music style.

5. The music search system according to claim 2, wherein the search unit additionally inputs the search keyword input by the user and the sub category selected by the user to the learning model to search the one or more candidate music.

6. The music search system according to claim 1, further comprising:
a reproducer which, if music selected from the candidate music is input from the user, receives the selected music from a music content providing server in a streaming manner to play the music through the user terminal.

7. The music search system according to claim 2, wherein the level value for the main category is set to five levels and an initial level value is set to a reference level.

8. The music search system according to claim 2, wherein the input unit further receives at least one user information, among gender, age, nationality, occupation, religion, a residential area, a mainly used time line of the user terminal, MBTI information, and a blood type, from a plurality of users and
the learning unit trains the learning model by setting a plurality of user information as input data and setting the set level value for the main category of each user as output data.

9. The music search system according to claim 8, wherein the learning unit sets an initial level value for each main category using the user information of the corresponding user in advance.

10. The music search system according to claim 1, wherein according to the learning model, the tempo category is trained with a higher level value for a faster tempo, the beat category is trained with a higher level value for a stronger rhythm intensity, the electric (EDM) category is trained with a higher level value as a proportion occupied by electronic sound, an effect modulation, and a sound effect in the music increases, the vocal category is trained with a higher level as a proportion of the vocal in the music increases, the spatial density category is trained with a higher level value as more instruments and sound types are played simultaneously, the time density category is trained with a lower level value as a gap of a playing time is longer, the brightness category is trained with a lower level value as an atmosphere is brighter, and the popularity category is trained with a higher level value as it is less likely to be disliked by an unspecified number of people.

11. The music search system according to claim 1, wherein the learning model is based on a temporal convolution network (TCN) algorithm.

12. A music search method performed by a music search system, comprising:
a step of training a learning model by setting a plurality of candidate music as input data and setting a level value for a main category including a tempo, a beat, an electric (EDM), a vocal, a spatial density, a time density, a brightness, and a popularity for the music, as output data;
a step of quantizing and storing an attribute for each main category for the each extracted candidate music as the level value;
a step of receiving the level value for at least one main category, among the tempo, the beat, the electric (EDM), the vocal, the spatial density, the time density, the brightness, and the popularity, from a user; and
a step of searching one or more candidate music and providing the searched candidate music to a user terminal by inputting the input level value for each main category to the previously trained learning model.

13. The music search method according to claim 12, wherein in the step of receiving, at least one search keyword, among a title, a singer's name, an album title, and lyrics is further input from the user and a sub category for the main category is further input.

14. The music search method according to claim 13, wherein when the main category is the vocal, the sub category of the vocal is classified into normal, rap, and mixed based on a music style, is classified into normal and introvert based on the lyrics, is classified into general, Christian, and Buddhish music based on religion, and is classified into male and female based on gender.

15. The music search method according to claim 13, wherein when the main category is the spatial density, a sub category of the spatial density is classified into general, Western classic, and Oriental classic based on a music style and
when the main category is the time density, a sub category of the time density is classified into general, rock, and jazz based on the music style.

16. The music search method according to claim 13, wherein in the step of searching one or more candidate music and providing the searched candidate music to a user terminal, the search keyword input by the user and the sub category selected by the user are additionally input to the learning model to search the one or more candidate music.

17. The music search method according to claim 12, further comprising:
a step of receiving the selected music from a music content providing server in a streaming manner if music selected from the candidate music is input from the user to play the music through the user terminal.

18. The music search method according to claim 13, wherein the level value for the main category is set to five levels and an initial level value is set to a reference level.

19. The music search method according to claim 13, wherein in the step of receiving, at least one user information, among gender, age, nationality, occupation, religion, a residential area, a mainly used time line of the user terminal, MBTI information, and a blood type is further input from a plurality of users, and
in the step of training, the learning model is trained by setting a plurality of user information as input data and setting the set level value for the main category of each user as output data.

20. The music search method according to claim 19, wherein an initial level value is set in advance for each main category using the user information of the corresponding user.

21. The music search method according to claim 12, wherein according to the learning model, the tempo category is trained with a higher level value for a faster tempo, the beat category is trained with a higher level value for a stronger rhythm intensity, the electric (EDM) category is trained with a higher level value as a proportion occupied by electronic sound, an effect modulation, and a sound effect in the music increases, the vocal category is trained with a higher level as a proportion of the vocal in the music increases, the spatial density category is trained with a higher level value as more instruments and sound types are played simultaneously, the time density category is trained with a lower level value as a gap of a playing time is longer, the brightness category is trained with a lower level value as an atmosphere is brighter, and the popularity category is trained with a higher level value as it is less likely to be disliked by an unspecified number of people.

22. The music search method according to claim 12, wherein the learning model is based on a temporal convolution network (TCN) algorithm.
